(19) United States
(12) Patent Application Publication
(10) Pub. No.: US 2014/0198098 A1
(43) Pub. Date: Jul. 17, 2014

(54) Experience Enhancement Environment

(71) Applicant: Tae Joo, Redmond, WA (US)

(72) Inventor: Tae Joo, Redmond, WA (US)

(21) Appl. No.: 13/742,365

(22) Filed: Jan. 16, 2013

(51) Int. Cl. G06T 15/20

(52) U.S. Cl. CPC G06T 15/205
USPC 345/419

(57) ABSTRACT

Frames are transformed from a first set of frames to a second set of frames that yield enhanced perception.

### BACKGROUND

Various problems persist in the art of enhanced experience environments. One problem occurs in the area of three dimensional (3D) viewing, where a solution so far involves stereoscopic glasses that need to be worn by viewers. Glasses can be either active, e.g., liquid crystal shutter glasses, or passive, e.g., linearly polarized glasses, circularly polarized glasses, or interference filter glasses. However, all these solutions require the cost and inconvenience of buying and wearing glasses.

Autostereoscopy is another solution to a 3D viewing problems. This solution can provide 3D images without glasses. It can use either head-tracking technology to ensure that each of a viewer's eyes sees a different image, or it can display multiple views so that a display is independent of a viewer's eyes, e.g., using displays based on parallax barrier, lenticular, volumetric, electro-holographic, or light field technologies. However, autosteroscopic technologies are limited by the head movement of viewers, especially in a horizontal plane. Moreover, this technology is generally dependent on the zone in which a user resides.

Another set of problems involves exposing users to depth perception via current 3D technology that can result in physiological health hazards, including eye strain. For example, 3D glasses can cause eye strain by forcing users to focus for prolonged periods of time at predetermined distances. Furthermore, 3D technology suffers from the same limitations as its predecessor technologies, namely, the inability to provide on-the-fly dynamic content (as opposed to prepackaged static content) to be experienced by users.

What is needed is an experience enhancement technology that can confer benefits to solve these problems, including a minimal equipment dependent (yet rich) perception experience, reduction in eye strain, and allowance for dynamic introduction of content.

### BRIEF DESCRIPTION OF THE DRAWINGS

Any Figure (Fig.) illustrated or described herein is intended to convey an exemplary and not limiting aspect of the present disclosure.

FIG. 1 illustrates a transformation component that is configured to receive a first set of frames and transform them into a second set of frames, resulting in an enhanced experience when viewing the second set of frames;

FIG. 2 illustrates aspects of a transformation component, including input and output components, and memory and processing components;

FIG. 3 illustrates various components for enhancing experience, including a management component, a frame generation component, and a perception generation component that can enhance depth perception, append advertising information, and reduce eye strain;

FIG. 4 illustrates aspects of a perception generation component, including a pictorial component, a physiological component, and a stereoscopic component that may alone or in combination add depth perception cues;

FIG. 5 illustrates aspects of a transformation component, including object handling and processing to add depth perception cues to various objects;

FIG. 6 illustrates aspects of a transformation component, including a management component that can include an analysis component, an object attribute component, and an appending component that can add depth perception cues to frames;

FIG. 7 illustrates aspects of appending new objects in frames, where the new objects can represent advertising content;

FIG. 8 illustrates aspects of a transformation component, including eye strain reduction mechanisms; and,

FIG. 9 illustrates a flow chart indicating a process for enhancing perception.

### DETAILED DESCRIPTION

A frame can be a measure of content. In this capacity, a frame can vary in size depending on context, and encompass various types of content, such as objects, which can also be understood as members of a given set of content. Content can include auditory content, visual content, haptic content, or just about any other type of content associated with perception or sensing. Content can be directly in a frame or serve as a reference to other content. For example, auditory and visual content can be directly in a frame in the form of sound and pictures, respectively, and haptic content can reference or trigger other content outside the frame. Any of the different types of content can be directly in a frame or serve as a reference to content outside the frame. Specific types of content can include pictures, images, graphics, stills, sound, music, noise, references to touch, smell, taste, and so on. All these are merely exemplary and non-limiting types of content. They can be manipulated or processed by a variety of different components.

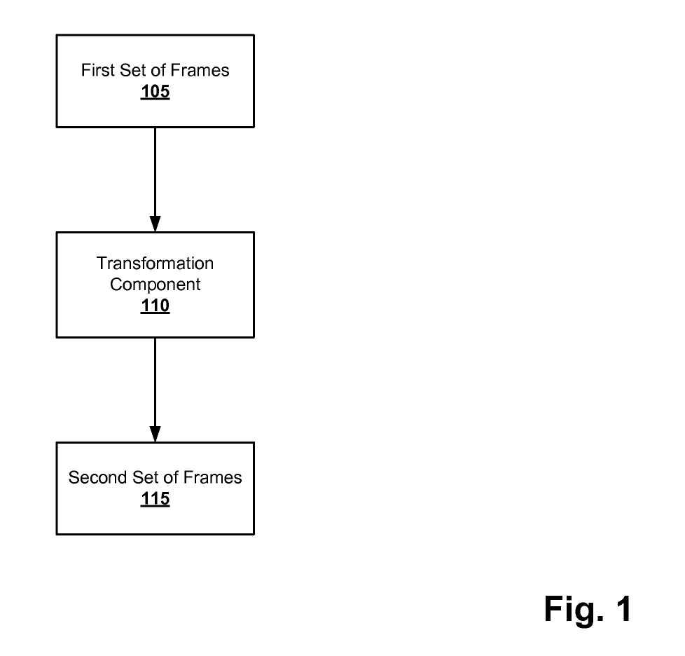

FIG. 1 illustrates a transformation component 110. The transformation component 110 can be configured to receive a first set of frames 105, where a set can include zero, one, or two or more frames, depending on context. Upon receipt of the first set of frames 105, the transformation component 110 can process the frames 105. After processing, the transformation component 110 can be configured to output a second set of frames 115. Receipt of the first set of frames 105 and output of the second set of frames 115 can be accomplished either directly or indirectly with respect to other components, either in whole or part. The second set of frames 115 can be either a new set of frames relative to the first set of frames 105 or it can be a composite set of frames that includes aspects of the first set of frames 105.

The first set of frames 105 can be based on a standard set of frames, e.g., 24, 25, or 30 frames per second (FPS), a non-standard set of frames, or a high frame rate set, e.g., 240, 250, 300 FPS, or more. The transformation component 110 can process input frames, and output them into any set of FPS. In one aspect, a standard 24 FPS set of frames (that can include three of the same images per frame resulting in 72 total images) is input into the transformation component 110, and the output is a 300 high frame rate set of frames. This output can dedicate 10, 12, 14 (or any number N) of output frames per any one input frame. The input frames can serve as content basis for the output frames, where the output frames can represent enhanced content relative to the input frames.

In one aspect of processing, perception can be enhanced by inducing depth perception in the output frames. Depth-perception can involve complex processing of inter-dependent cues. It can include recognizing objects and determining spatial relationships among objects at different locations in any given frame. The human visual system can use several depth cues synergistically to result in an enhancement of depth perception. The transformation component 110 can change the first set of frames 105 to the second set of frames 115. Such changes can include addition of objects, deletion of objects, manipulation of objects, etc., to result in an alteration of the contents of first set of frames 105 to result in the second set of frames 115.

Alteration of contents to induce depth perception by way of the second set of frames 115 can be accomplished by applying pictorial cues to the first set of frames 105, including but not limited to: occlusion, where some objects block other objects, thereby appearing relatively closer; relative size, where objects that are bigger appear closer; shadowing and foreshortening objects, thereby implying depth; varying the distance horizon to imply size, and therefore depth; familiar object size use, to exploit expectations of size; shading, to imply depth; color use, where certain colors imply distance, such as bluer objects appearing far because of atmospheric effects; relative brightness, where brighter object may appear closer; focus, where distant objects may appear blurrier; texture, where objects with fine or clear patterns may appear closer than other objects; linear perspective, where objects converge with distance; and so on. These cues can be applied alone, in any combination with one another or other cues.

In addition to, or in lieu of pictorial cues, physiological cues can be applied to the first set of frames 105 that results in the second set of frames 115. Physiological cues can be induced by manipulation of objects in any given frame, and they include but are not limited to: convergence of objects that results in the rotation of the eyes toward a single location in space; accommodation of objects that causes the focusing of eye lenses at a particular distance; invoking of motion parallax that causes closer objects to appear to move faster than distant objects; kinetic occlusion of objects that results in change in perception of objects due to motion; and, familiar speeds that leverage expectations of speed.

Pictorial and physiological cues can be used singularly or in combination with each other. Any of these cues can be used to induce depth perception and/or to reduce eye strain that often accompanies viewing objects using 3D technology. Thus, in one aspect, these cues can be used as a substitute for stereoscopic technology. Alternatively, in another aspect, these cues can be used to further enhance any stereoscopic technology. Since stereoscopic effects may be more relevant at near-field depth perception than far-field depth perception, more applicable to relative depth rather than absolute depth judgment, the presently disclosed cues can significantly enhance any stereoscopic technology.

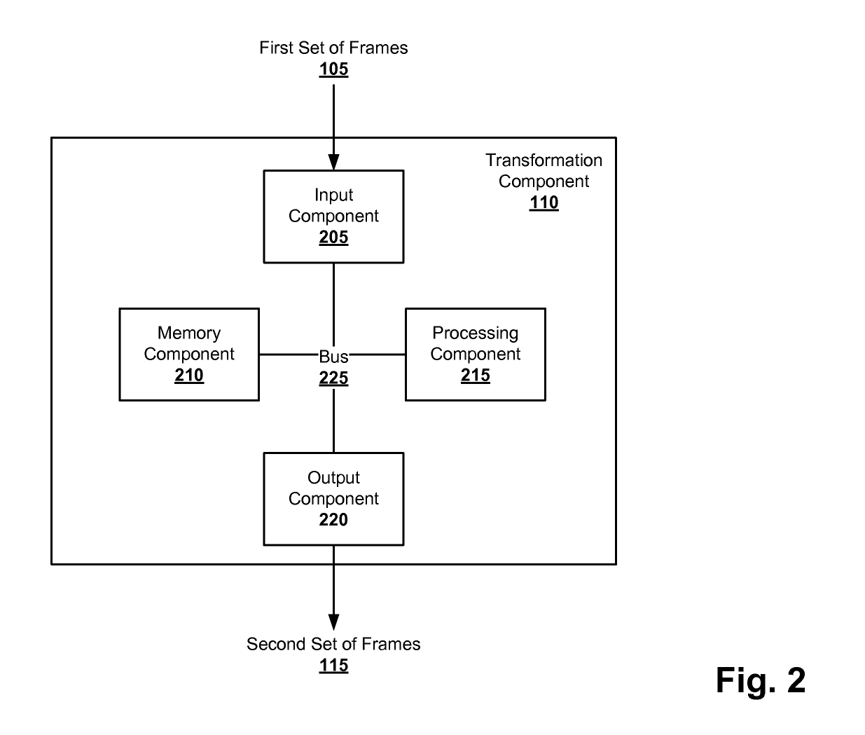

FIG. 2 illustrates various components that can be included in the transformation component 110. In one example aspect, the first set of frames 105 can contain standard frame rate video images that are received by an input component 205. This input component 205 can be a memory storage medium (volatile or non-volatile), e.g., a buffer. Video images can be processed by a processing component 215, e.g., a central processing unit, resulting in high frame rate video images that can induce increased depth perception by viewers. The video images can be processed according to cues stored in a memory component 210 of the transformation component 110. The resultant video images can then be sent to the output component 220. The video images can also reside in the memory component 210, where cues and processing commands stored in the memory component 210 and executed by the processing component 215 can be seamlessly communicated via a bus 225. The resultant high frame rate video images can be outputted as the second set of frames 115.

Video images are merely exemplary forms of content that can be processed. The transformation component 110 can process television images, video game images, computer graphics images, computer simulation images, teleconference images, and so on. As mentioned above, any type of technology can be processed that can result in a high frame output configured for enhanced perception.

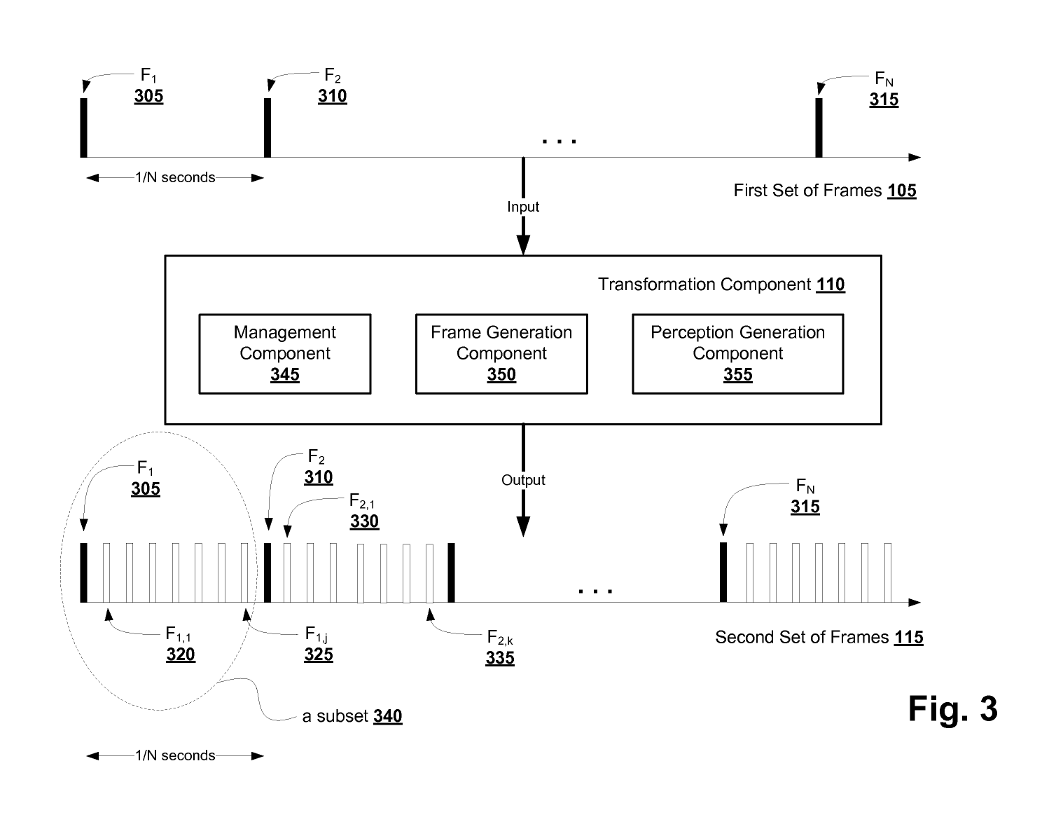

FIG. 3 illustrates an exemplary aspect of how frames can be transformed in order to induce depth perception. A first set of frames 105 can be represented as a series or set of frames F₁, F₂, . . . F_{N}, shown in FIG. 3 as F₁ 305, F₂ 310 up to F_{N} 315. This first set of frames 105 is illustrated with black bars on a time domain. This series can be separated by 1/N seconds, where N is the total number of frames. The first set of frames 105 can be input into the memory component 210 of the transformation component 110. The output of the memory component 210 can include the first set of frames 105 and an additional second set of frames (shown with white bars) that is based on the first set of frames 105. The second set of frames 115 can include aspects that induce depth perception relative to the first set of frames 105. In one aspect, in the first set of frames 105, the time between frames, e.g., F₁ 305 and F₂ 310 can be 1/N seconds, and in the second set of frames 115, the time between frames, e.g., F₁ 305 and F₂ 310 can also be 1/N seconds. In different aspects, the time between frames can vary, in others it can be substantially similar.

The second set of frames 115 can include a total of the first set of frames 105 (black bars) along with the additional set of frames (white bars) with depth perception qualities. This additional set of frames (or intermediate set of frames) can be represented as a series of frames F_{1,1} 320 . . . F_{1,j} 325, or F_{2,1}330 . . . F_{2,k} 335, and so on. The variables “j” and “k” in this series can have various values, depending on the amount of additional frames needed or desired for each frame of the first set of frames 105. In one aspect, the additional set of frames can represent gradual changes in content, so that if frame F₁ 305 contains an original content, frame F_{1,1} 320 can contain this content but slightly changed (via any of the above cues), and frame F_{1,j} 325 can contain this content but even more changed—any of the frames between frames F_{1,1} 320 and F_{1,j} 325 can change content either linearly or non-linearly, employing any of the cues discussed above.

For each subset 340 “s” of the second set of frames 115, a basic formula can be derived for a particular subset:

$$F ( s ) = \{ {F}_{s} , {{}_{i = 1}}^{n} {F}_{s , i} \}$$

The operator “V” above, is a collection operator for collecting a set of frames. For each frame of the first set of frames 105, ranging from 1 to N, a corresponding second set of frames 115 can be derived. For example, for a first subset with s=1, yields F(1)={F₁, F_{1,1}, F_{1,2}, . . . F_{1,n}}. In FIG. 3, in one particular aspect n=j. This series culminates in a subset 340. There can be N such subsets in FIG. 3, and each subset can have any number of required or desired frames.

In another aspect, original input frames, such as frame F₁305 can be omitted so that a new second set of frames 115 can comprise of the additional frames:

$$F ( s ) = \{ {{}_{i = 1}}^{n} {F}_{s , i} \}$$

Furthermore, any selected subset (not shown) of a given subset 340 can be used to induce depth perception, especially if quality is not compromised or if compression and size are taken into account. Thus, at least three variations of any given subset are contemplated herein. For example, subset F(1) can be fully expressed as F(1)={F₁, F_{1,1}, F_{1,2}, . . . F_{1,n}}, or alternatively as F(1)={F_{1,1}, F_{1,2}, . . . F_{1,n}} (without an original input frame, F₁) or finally in compressed manner, such as F(1)={F_{1,1}, F_{1,2}, . . . F_{1,10}} (containing a subset of any subset 340). Any combination, including omission, of the first set of frames 105 and the additional frames (or subset thereof) can be blended to construe the second set of frames 115.

FIG. 3 illustrates that input frames can be manipulated by additional components before being output. First, a management component 345 can govern the number of additional frames that will be generated to create the second set of frames 115. In one aspect, the second set of frames can contain an order of magnitude more frames than an input set of frames, as when generating a high frame rate set of frames based on a typical input set of frames. This component 345 can instruct a frame generation component 350 to construct template frames. Next, the management component 345 can instruct a perception generation component 355 to create various depth perception qualia that can be appended to the template frames generated by the generation component 350. The content of the template frames can be based on the input frames, either based on the content (e.g. objects) within the input frames and/or references to other content outside the input frames.

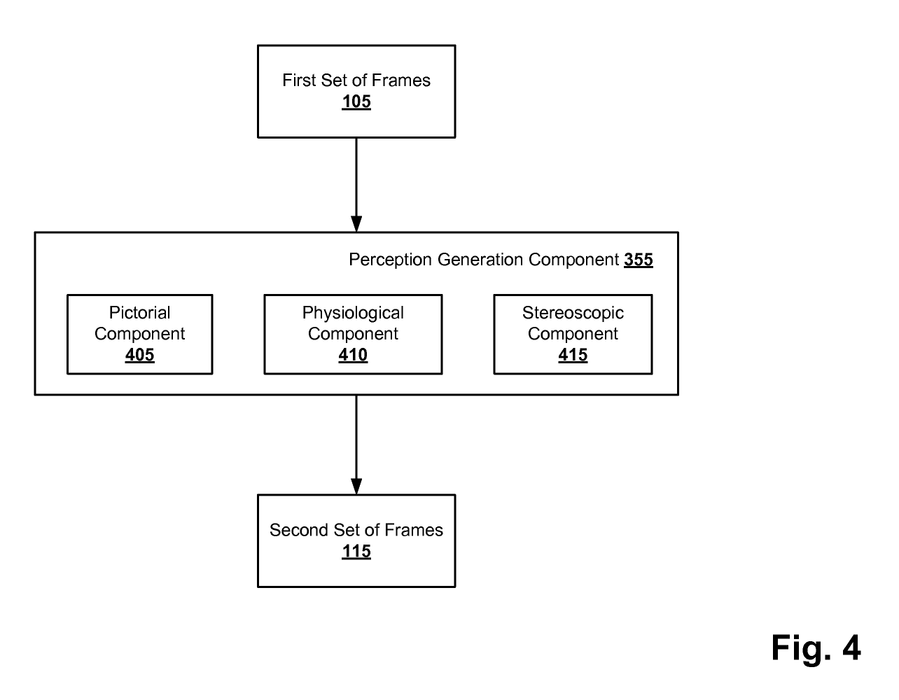

FIG. 4 illustrates one aspect of how various depth perception cues can be appended to input frames to generate enhanced output frames. A first set of frames 105 can be input into a perception generation component 355 that can be configured to output a second set of frames 115. The perception generation component 355 can append depth perception cues to incoming first set of frames 105 via a pictorial component 405, a physiological component 410, or a stereoscopic component 415. The result of such appending can be the second set of frames 115.

For example, with respect to any objects in the first set of frames 105, the pictorial component 405 can create occlusion among the objects, change relative size of objects, add shadowing and foreshortening to them, vary the distance among them horizon, rely on familiar size, introduce shading, change colors, adjust relative brightness, readjust focus and texture, enhance resolution (e.g., enhance object resolution by selecting an object of interest, enlarging its size, accentuating its edges, while blurring the background), and so on. Analogously, the physiological component 410 can manipulate any objects in any of the frames of the first set of frames 105, such that the objects induce convergence, accommodation, motion parallax, kinetic occlusion, and so on. The pictorial and physiological components 405, 410 can be used separately, together, or in conjunction with a stereoscopic component 415 that can provide stereoscopic cues that induce depth perception.

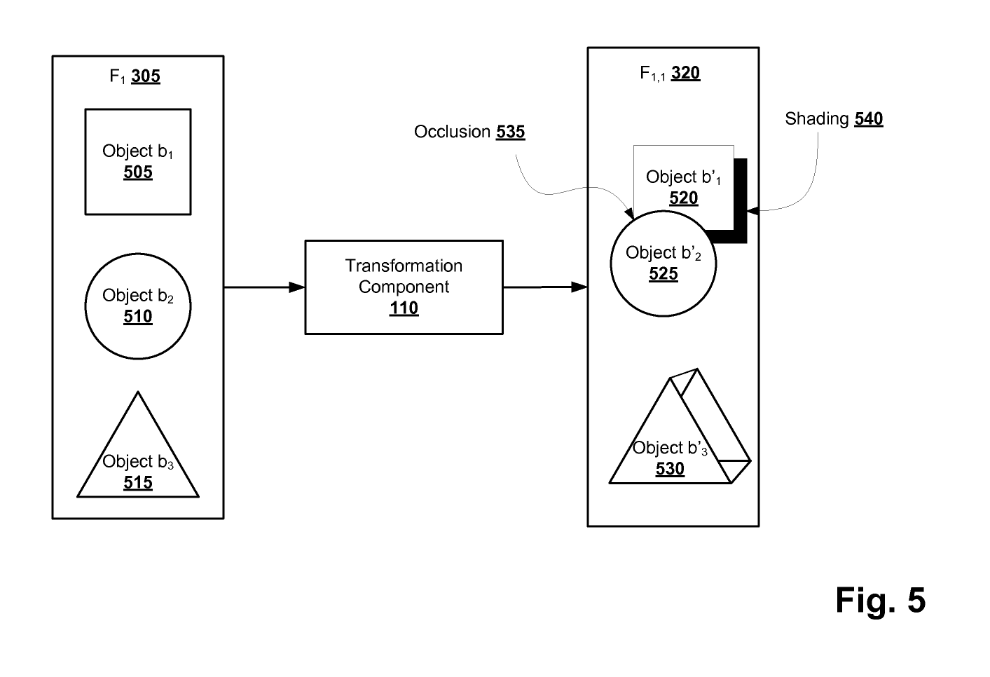

FIG. 5 illustrates another aspect of how various depth perception cues can be appended. An input frame F₁305 can contain among its contents several objects, such as object b₁505, object b₂ 510, and object b₃ 515. This frame 305 can be input into a transformation component 110 that can output frame F_{1,1}320. As can be seen in FIG. 5, object b₁505 is transformed into object b′₁520, where the latter object is moved, made smaller, and placed behind object b₂ 525. In frame 305, object b₁ 505 and object b₂ 510 appear flat in contrast to frame 320, where object b′₁520 and object b′₂ 525 provide a cue to depth perception, by showing object b′₁520 occluded by object b′₂ 525.

In FIG. 5, object b′₁520 is appended with two different types of cues. In addition to occlusion 535, object b′₁520 is also shaded 540 to provide an additional depth cue. FIG. 5 also illustrates the transformation of object b₃ 515 to object b′₃ 530. In this situation, object b₃ 515 is appended with linear perspective to imply depth. The relationship among frames, object, and cues can be a logical combination of, respectively, one frame-to-one object-to-one cue (1:1:1), one frame-to-one object-to-many cues (1:1:M), and so on until many frames-to-many objects-to-many cues (M:M:M).

In one appending aspect, depth perception cues can be appended via an append or transformation operation. Depth perception cues can be applied on a granular object-by-object basis. Thus, in this aspect, for each object “b” in any given frame “F”, such object can be subject to a transformation. In different aspects, depth cues can be appended on whole frame-by-frame basis, or a on pixel-by-pixel basis, or on a content-by-content basis.

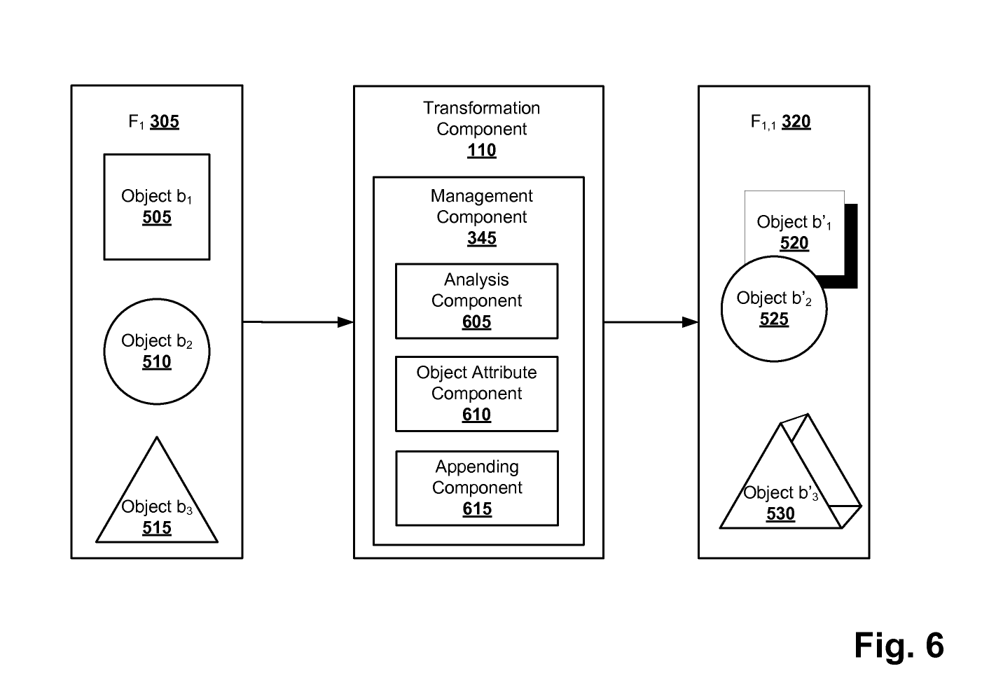

FIG. 6 illustrates one aspect of the mechanics of the append operation. A management component 355 can request the creation of various depth perception cues via an append operation. Appending cues can be created by analyzing a frame with an analysis component 605. The analysis component 605 can identify individual objects within a frame. For example, the analysis component 605 can identify object b₁505 in frame F₁305. The object attribute component 610 can then determine the attributes of object b₁505, such as the location of the object within frame F₁305, the size and boundaries of the object. Other attributes can be context dependent, such as visual attributes for image frames or sound attributes for audio frames. After determination of the attributes, the appending component 615 can place perception inducing cues onto object b₁505 in the appropriate place. The placement of such cues can be a function of the examined attributes.

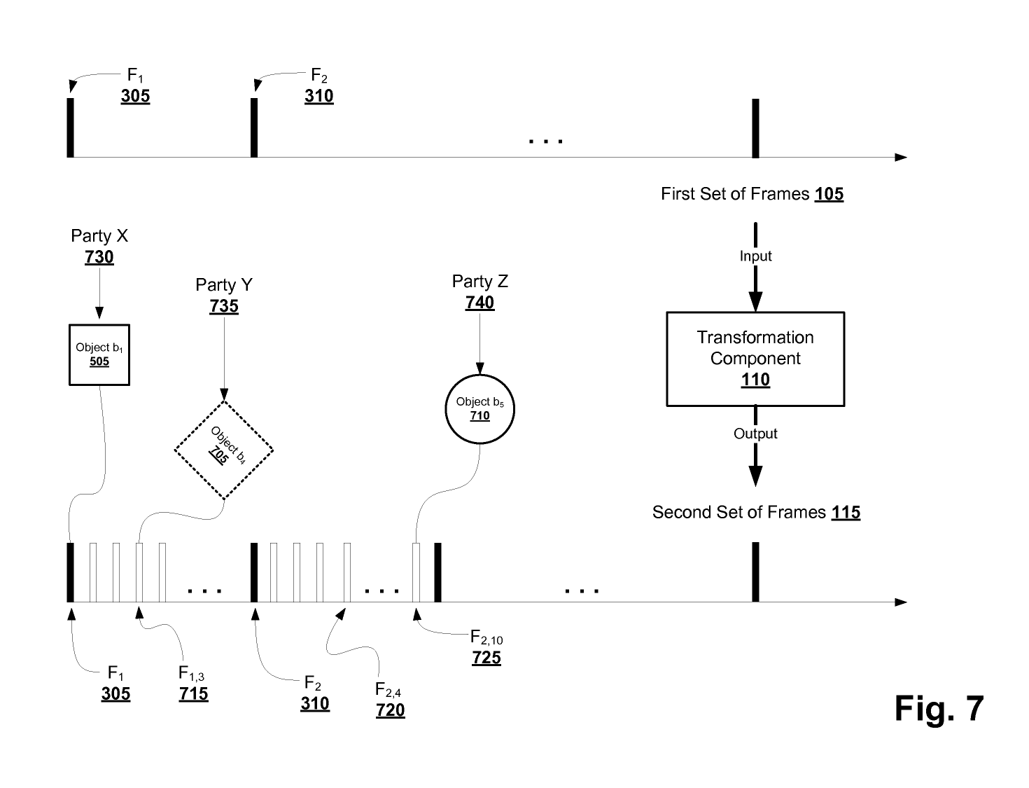

FIG. 7 illustrates one aspect of appending information into frames. In FIG. 6, the append operation could be used to introduce depth perception cues onto objects within any given frame. The append operation can also be used for an additional purpose, such as introducing new objects into frames. These new objects can be based on existing objects within any given frame or they can be independent of the existing objects.

In one example, the new objects can be advertising content. Such advertising content can comprise images. As is shown in FIG. 7, a first set of frames 105 can be transformed into a second set of frames 115 by a transformation component 110. This transformation can include (in addition to, or in lieu of depth perception cues) the introduction of new objects into the second set of frames 115. Frame F₁305 can originally contain object b₁ 505 in the first set of frames 105. Related to this object 505, another new object b₄ 705 can be constructed. If, for instance, object b₁505 is an item in a movie with N number of frames, object b₄ 705 can be another item in the movie. This object 705 can be a means to advertize objects based on the subject matter of object b₁505.

Objects b₁505 and b₄ 705 can be owned by, controlled by, or merely associated with various parties, such as party X 730 and party Y 735, respectively, which may include individuals, corporations, or any other organizational entities. In one example, party Y 735 can buy advertising space and advertize object b₄ 705. The transformation component 110 would place object b₄ 705 in the movie. In one aspect, object b₄ 705 could be a token object that could be cashed out any time (or most times, or sometimes) that related object b₁505 appears in a movie. If, for instance, party X 730 is a car manufacturer, party Y 735 could be a tire manufacturer, so that any time the car appears, party Y's 735 brand of tires is appended to the car. Moreover, party W (not shown) could outbid party Y 735 and present its set of tires instead. In short, the type of objects and content in this technology are dynamic.

In another aspect, new objects need not be based on object b₁505, but can instead be introduced from outside the N number of frames and can be included by the transformation component 110. Object b₅ 710 can be introduced as advertizing content to be inserted into the movie. Such content can be introduced at the request of Party Z 740 that may wish to advertize object b₅ 710. The transformation component 110 can arbitrate what advertising objects to introduce, how to introduce them, how to change them, how to maintain them, for how long, and so on.

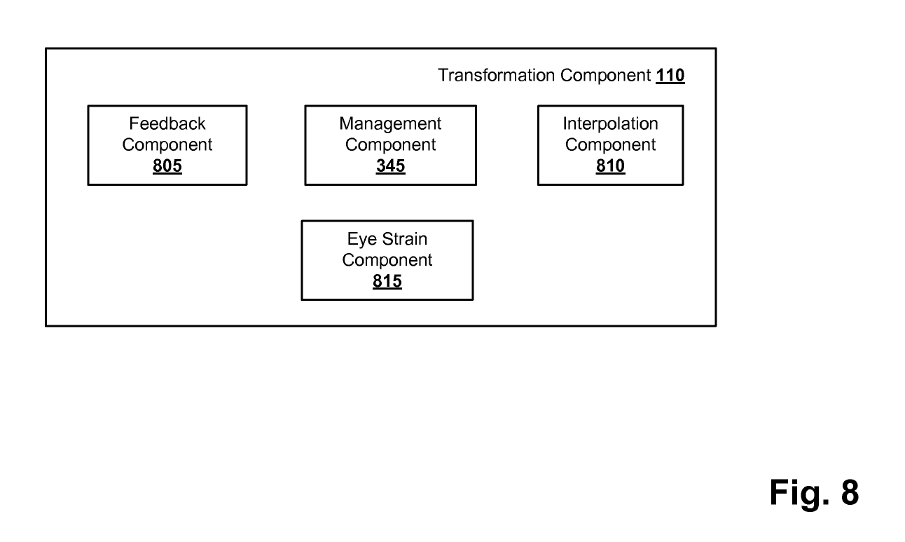

FIG. 8 illustrates another aspect of the experience enhancement environment, namely, the ability of the transformation component 110 to reduce eye strain by manipulating objects within frames. Such manipulation can be executed while adjusting depth perception cues. The transformation component 110 can include a feedback component 805 that can observe viewers. For example, a camera can be employed by the feedback component 805 to track viewers' eyes. This tracking can be provided to the management component 345 to determine if viewers' eyes have been strained from watching content in the second set of frames 115. Various heuristics can be used to accomplish this, including observing prolonged focus of the eye balls, lack of eye movement, and so on. Such heuristics can be stored in an eye strain component 815 that is accessible by the management component 345.

The feedback component 805 can not only be instantiated as a camera system, but can also include an auditory component (not shown). The auditory component can monitor noise levels in the surrounding environment and adjust the volume associated with the second set of frames 115. Such noise levels can include ambient noise or the perceived noise by the viewers (microphones and cameras can together or alone aid in such determination). Various heuristics can be used to determine comfortable noise level for viewers, including dynamically adjustable expected decibel levels and predetermined noise levels that comport with health standards. Expected and predetermined levels can be set in an interpolation component 810. Any of these and above stored heuristics 810, 815 can be applied by the transformation component 110.

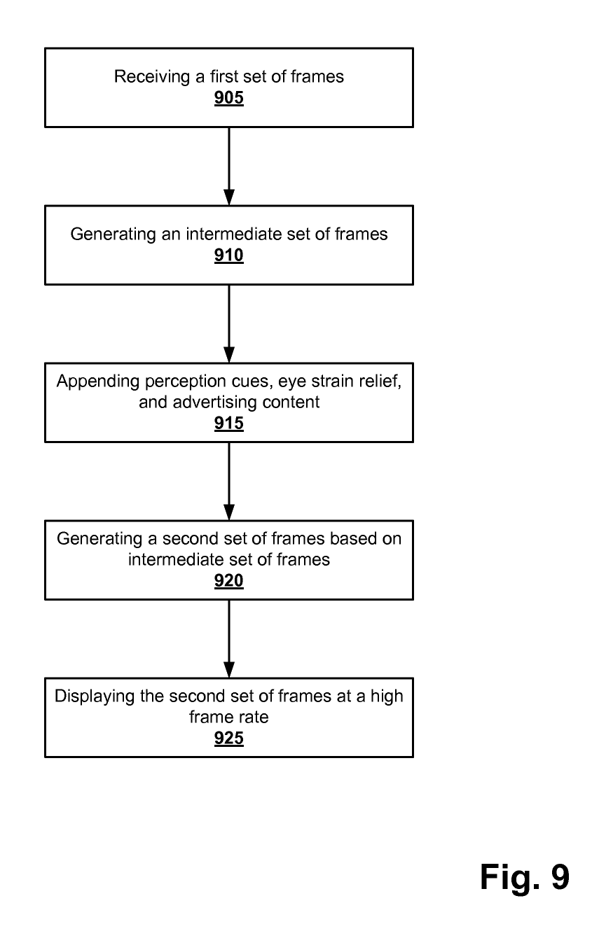

FIG. 9 illustrates a flow chart indicating a process for enhancing perception. The process can be performed in any logical order. At block 905, a first set of frames is received. This set of frames can be received via any electronic communications medium or it can be stored locally. Once it is received, it is processed. Processing can entail an analysis of the content of the frames, including the subject matter, its objects, and the like. At block 910, an intermediate set of frames can be generated. This set of frames can include content that is either independent from the content in the first set of frames or is derivative of the content in the first set of frames, or both. In either case, at block 915, this content can have appended information to it, including perception cues, e.g., depth perception, eye strain relief cues, or advertising content. When all the desired content is appended to the frames, a composite set of second frames can be generated at block 920. This second set of frames is ready for display at block 925. The frame rate display of this second set of frames can be set at a high frame rate to induce a fluid and enhanced viewing experience.

1. An experience enhancement environment, comprising:
a component configured to receive a first set of frames associated with a first frame rate; and,
a transformation component configured to transform said first set of frames to a second set of frames associated with a second frame rate substantially higher than said first frame rate;
wherein said transformation component is configured to append depth perception cues residing in said second set of frames.

2. The environment according to claim 1, wherein said depth perception cues include at least one of pictorial cues, physiological cues, or stereoscopic cues.

3. The environment according to claim 1, wherein said depth perception cues are appended on an object-by-object basis in at least one frame of said second said of frames.

4. The environment according to claim 1, wherein said second frame rate is about an order of magnitude larger than said first frame rate.

5. The environment according to claim 1, wherein said transformation component is configured to add to said second set of frames advertising objects.

6. The environment according to claim 1, wherein said transformation component is configured to reduce eye strain by manipulating depth perception cues in said second set of frames.

7. The environment according to claim 1, wherein said transformation component resides on at least one of a client device, a server device, or a mobile device.

8. A method of inducing enhanced perception, comprising:
receiving frames;
configuring said frames from one frame rate to another frame rate;
generating additional frames to said frames; and,
appending perception cues to at least one frame of said additional frames.

9. The method according to claim 8, further comprising:
generating a composite set of frames that includes said additional frames and said received frames.

10. The method according to claim 9, further comprising:
generating a composite frame rate for said composite set of frames at said another frame rate.

11. The method according to claim 10, further comprising:
displaying said composite set of frames on a mobile device.

12. The method according to claim 8, wherein said perception cues include at least one of depth perception cues or eye strain reduction cues.

13. The method according to claim 8, wherein said another frame rate is a high frame rate relative to said one frame rate.

14. The method according to claim 8, further comprising:
adding at least one advertising object within at least one frame of said additional frames.

15. A computer readable medium storing computer readable instructions for transforming frames, comprising:
a first set of instructions configured to manage receiving a first set of frames;
a second set of instructions configured to generate an intermediate set of frames that are at least in part based on said first set of frames;
a third set of instructions configured to add perception cues to at least one of said first set of frames or said intermediate set of frames;
a fourth set of instructions configured to mix said first set of frames and said intermediate set of frames to form a blended set of frames; and
a fifth set of instructions configured to set said blended set of frames to a high frame.

16. The computer readable medium according to claim 15, wherein said high frame rate is about at least 100 frames per second.

17. The computer readable medium according to claim 15, wherein said set of intermediate frames is configured to have objects with added depth perception cues.

18. The computer readable medium according to claim 17, wherein said set of intermediate frames is configured to reduce eye strain.

19. The computer readable medium according to claim 17, wherein said set of intermediate frames is configured to include advertising content.

20. The computer readable medium according to claim 15, wherein at least one of said set of computer readable instructions is configured to execute remotely from the rest.
